(19) United States
(12) Patent Application Publication
(10) Pub. No.: US 2026/0010097 A1
(43) Pub. Date: Jan. 8, 2026

(54) POWDER CONTAINER AND IMAGE FORMING APPARATUS

(71) Applicant: Ryusuke MASE, Kanagawa (JP)

(72) Inventor: Ryusuke MASE, Kanagawa (JP)

(21) Appl. No.: 19/248,499

(22) Filed: Jun. 25, 2025

(30) Foreign Application Priority Data
Jul. 4, 2024 (JP) 2024-107813

(51) Int. Cl. G03G 15/08

(52) U.S. Cl. CPC G03G 15/0886; G03G 15/0863; G03G 15/0865

(57) ABSTRACT

A powder container includes a container body, a cap, a shutter, and an information storage medium. The store powder in the container body and is detachably attachable to an apparatus body of an image forming apparatus in an attachment direction. The cap has a through hole having an entrance at a downstream end of the through hole in the attachment direction and covers a portion of the container body. The shutter is fittable to the through hole and openably closes the through hole in response to an attachment and a detachment of the container body to and from the apparatus body. The information storage medium is on the cap, is disposed downstream from the entrance of the through hole in the attachment direction, and is electrically communicable with the image forming apparatus in response to the attachment of the container body to the apparatus body.

### CROSS-REFERENCE TO RELATED APPLICATION

This patent application is based on and claims priority pursuant to 35 U.S.C. § 119(a) to Japanese Patent Application No. 2024-107813, filed on Jul. 4, 2024, in the Japan Patent Office, the entire disclosure of which is hereby incorporated by reference herein.

### BACKGROUND

### Technical Field

The present disclosure relates to a toner container that stores toner therein, and an image forming apparatus such as a copier, a printer, a facsimile, or a multifunction peripheral thereof including the toner container.

### Related Art

Image forming apparatuses such as copiers and printers are known in which a substantially cylindrical toner container attachable to and detachable from an apparatus body of an image forming apparatus is disposed.

### SUMMARY

The present disclosure described herein provides powder container includes a container body, a cap, a shutter, and an information storage medium. The store powder in the container body and is detachably attachable to an apparatus body of an image forming apparatus in an attachment direction. The cap has a through hole having an entrance at a downstream end of the through hole in the attachment direction and covers a portion of the container body. The shutter is fittable to the through hole and openably closes the through hole in response to an attachment and a detachment of the container body to and from the apparatus body. The information storage medium is on the cap, is disposed downstream from the entrance of the through hole in the attachment direction, and is electrically communicable with the image forming apparatus in response to the attachment of the container body to the apparatus body.

The present disclosure described herein also provides an image forming apparatus that includes the powder container detachably attachable to the apparatus body of the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a cross-sectional view of an image forming device of the image forming apparatus of FIG. 1;

FIG. 3 is a schematic view of a toner supply device of the image forming apparatus and a vicinity of the toner supply device;

FIG. 4 is a cross-sectional view of a toner container;

FIG. 5 is a perspective view of a head of the toner container of FIG. 4;

FIGS. 6A and 6B are diagrams illustrating an operation of attaching a toner container to an apparatus body of the image forming apparatus;

FIGS. 7A and 7B are diagrams illustrating an operation of attachment and detachment of a toner container as a comparative example to and from an apparatus body of the image forming apparatus;

FIGS. 8A and 8B are perspective views of a head of a toner container according to a first modification;

FIGS. 9A and 9B are perspective views of a head of a toner container according to a second modification;

FIGS. 10A and 10B are views of a holding unit in the toner container of FIGS. 9A and 9B;

FIGS. 11A and 11B are partially enlarged diagrams illustrating an operation in which an ID chip of a toner container is installed in a reading device according to a third modification;

FIGS. 12A and 12B are partially enlarged diagrams illustrating a state just before an ID chip of a toner container is connected in a reading device according to a fourth modification; and

FIG. 13 is a schematic view of a toner supply device of an image forming apparatus and a vicinity of the toner supply device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

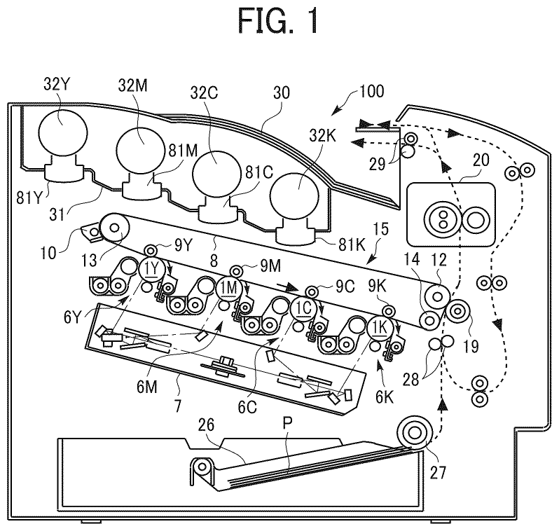

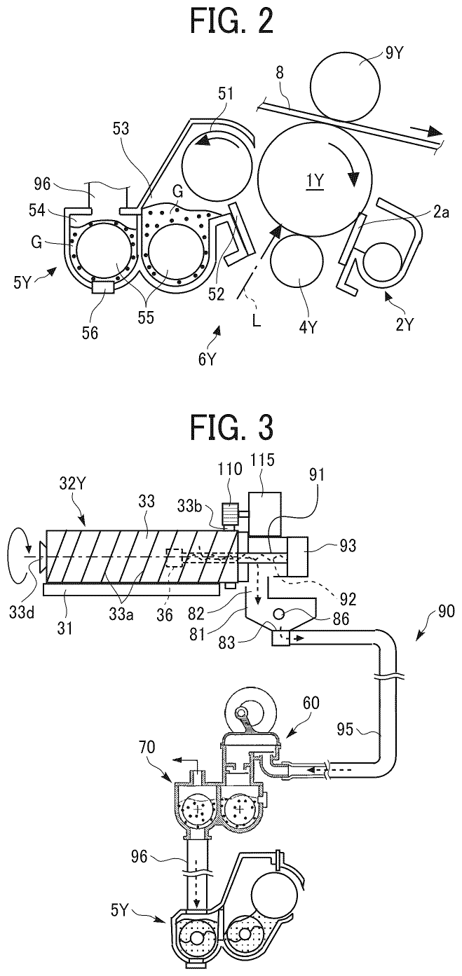

With reference to FIGS. 1 to 3, an overall configuration and operation of an image forming apparatus 100 are described below. FIG. 1 is a schematic view of a printer as the image forming apparatus 100. FIG. 2 is an enlarged view of an image forming device of the image forming apparatus 100. FIG. 3 is a schematic view of a toner supply device and the vicinity thereof. As illustrated in FIG. 1, the image forming apparatus 100 includes an installation section 31 (serving as a toner container rack) in an upper portion of an apparatus body of the image forming apparatus 100. Substantially cylindrical toner containers 32Y, 32M, 32C, and 32K are detachably (replaceably) attached to the installation section 31. The four toner containers 32Y, 32M, 32C, and 32K correspond to four colors, that is, yellow, magenta, cyan, and black, respectively. Below the toner containers 32Y, 32M, 32C, and 32K, hoppers 81Y, 81M, 81C, and 81K of toner supply devices are disposed, respectively. An intermediate transfer unit 15 is disposed below the installation section 31. Image forming devices 6Y, 6M, 6C, and 6K corresponding to colors of yellow, magenta, cyan, and black, respectively, are arranged side by side to face an intermediate transfer belt 8 of the intermediate transfer unit 15.

With reference to FIG. 2, the image forming device 6Y for yellow includes a photoconductor drum 1Y (an image bearer), a charging device 4Y, a developing device 5Y, a cleaning device 2Y, and an electric-charge removing device disposed around the photoconductor drum 1Y. Image forming processes (i.e., a charging process, an exposure process, a development process, a transfer process, a cleaning process, and an electric-charge removing process) are executed on the photoconductor drum 1Y. Thus, a yellow toner image is formed on the surface of the photoconductor drum 1Y.

The other three image forming devices 6M, 6C, and 6K have substantially the same configuration as that of the image forming device 6Y for yellow except for the color of toner used therein and form magenta, cyan, and black toner images, respectively. Only the image forming device 6Y is described below and descriptions of the other three image forming devices 6M, 6C, and 6K are appropriately omitted.

As illustrated in FIG. 2, a motor drives to rotate the photoconductor drum 1Y in a clockwise direction. The charging device 4Y uniformly charges the surface of the photoconductor drum 1Y (a charging process). When the surface of the photoconductor drum 1Y reaches a position at which the surface of the photoconductor drum 1Y is irradiated with laser beam L emitted from an exposure device 7 (a writing device, see FIG. 1), the photoconductor drum 1Y is scanned with the laser beam L. Thus, an electrostatic latent image corresponding to yellow is formed on the photoconductor drum 1Y (an exposure process).

When the surface of the photoconductor drum 1Y reaches a position facing the developing device 5Y, the electrostatic latent image is developed with toner into a yellow toner image (a development process). When the surface of the photoconductor drum 1Y bearing the toner image reaches a position facing a primary transfer roller 9Y via the intermediate transfer belt 8, at the position, the toner image on the photoconductor drum 1Y is transferred onto the intermediate transfer belt 8 (a primary transfer process). After the primary transfer process, a small amount of toner may remain untransferred on the photoconductor drum 1Y.

When the surface of the photoconductor drum 1Y reaches a position facing the cleaning device 2Y, a cleaning blade 2a collects untransferred toner from the photoconductor drum 1Y into the cleaning device 2Y (a cleaning process). Finally, the surface of the photoconductor drum 1Y reaches a position facing a charge neutralizer, and the charge neutralizer removes residual potentials from the photoconductor drum 1Y. Thus, a series of image forming processes executed on the surface of the photoconductor drum 1Y is completed.

The other image forming devices 6M, 6C, and 6K perform the series of image forming processes described above in substantially the same manner as the image forming device 6Y for yellow. That is, the exposure device 7 disposed below the image forming devices 6M, 6C, and 6K irradiates photoconductor drums 1M, 1C, and 1K of the image forming devices 6M, 6C, and 6K, respectively, with the laser beams L based on image data. Specifically, in the exposure device 7, a light source emits the laser beam L, which is deflected by a polygon mirror rotated. The laser beam L then reaches the photoconductor drum 1 via multiple optical elements. Thus, the exposure device 7 scans the surface of each of the photoconductor drums 1M, 1C, and 1K with the laser beam L. Then, toner images formed on the photoconductor drums 1M, 1C, and 1K through the development step are transferred and superimposed onto the intermediate transfer belt 8. Thus, a color toner image is formed on the intermediate transfer belt 8.

The intermediate transfer unit 15 includes the intermediate transfer belt 8, four primary transfer rollers 9Y, 9M, 9C, and 9K, a secondary-transfer counter roller 12, a cleaning backup roller 13, a tension roller 14, and an intermediate transfer cleaner 10. The intermediate transfer belt 8 is extended and supported by the secondary-transfer counter roller 12, the cleaning backup roller 13, and the tension roller 14. The secondary-transfer counter roller 12 serves as a driving roller to rotate the intermediate transfer belt 8 in the direction (counterclockwise) indicated by an arrow in FIG. 1.

The four primary transfer rollers 9Y, 9M, 9C, and 9K are pressed against the corresponding photoconductor drums 1Y, 1M, 1C, and 1K, respectively, via the intermediate transfer belt 8 to form primary transfer nips. A primary transfer bias opposite in polarity to toner is applied to the primary transfer rollers 9Y, 9M, 9C, and 9K. The intermediate transfer belt 8 travels in the direction (counterclockwise) indicated by an arrow in FIG. 1 and sequentially passes through the primary transfer nips of the primary transfer rollers 9Y, 9M, 9C, and 9K. As a result, the single-color toner images on the photoconductor drums 1Y, 1M, 1C, and 1K, having the respective colors, are primarily transferred and superimposed onto the intermediate transfer belt 8, thereby forming the multicolor toner image.

Subsequently, the intermediate transfer belt 8 onto which the toner images of the respective colors are transferred and superimposed reaches a position opposite a secondary transfer roller 19. At this position, the intermediate transfer belt 8 is nipped between the secondary-transfer counter roller 12 and the secondary transfer roller 19 to form a secondary transfer nip. The toner images of four colors formed on the intermediate transfer belt 8 are transferred onto a sheet P such as a sheet of paper conveyed to the position of the secondary transfer nip (a secondary transfer process). At this time, the untransferred toner that has not been transferred onto the sheet P remains on the surface of the intermediate transfer belt 8.

The surface of the intermediate transfer belt 8 then reaches a position opposite the intermediate transfer cleaner 10. At this position, the intermediate transfer cleaner 10 collects the untransferred toner from the intermediate transfer belt 8. Thus, a series of transfer processes performed on the intermediate transfer belt 8 ends.

The sheet P is conveyed from a sheet feeder 26 disposed in a lower portion of the apparatus body of the image forming apparatus 100 to the secondary transfer nip via a feed roller 27 and a registration roller pair 28. Specifically, the sheet feeder 26 contains a stack of multiple sheets P such as sheets of paper stacked on one on another. As the feed roller 27 is rotated counterclockwise in FIG. 1, the feed roller 27 feeds a top sheet P from the stack in the sheet feeder 26 to a roller nip between rollers of the registration roller pair 28.

The sheet P conveyed to the registration roller pair 28 (serving as a timing roller pair) temporarily stops at the roller nip between the rollers of the registration roller pair 28 that has stopped driving to rotate. The registration roller pair 28 is rotated at a timing at which the sheet P meets the color toner image on the intermediate transfer belt 8 at the secondary transfer nip, to convey the sheet P toward the secondary transfer nip. Thus, the desired color image is transferred onto the sheet P.

Subsequently, the sheet P, onto which the color toner image is transferred at the secondary transfer nip, is conveyed to a position of a fixing device 20. Then, at this position, the color toner image transferred to the surface of the sheet P is fixed on the sheet P by heat and pressure of the fixing roller and the pressure roller (a fixing process). The sheet P is conveyed through the rollers of an output roller pair 29 and ejected to the outside of the image forming apparatus 100. The sheets P ejected by the output roller pair 29 to the outside of the image forming apparatus 100 are sequentially stacked as output images on a stack tray 30. Thus, a series of image forming processes performed by the image forming apparatus 100 is completed.

Next, a detailed description is provided of a configuration and operations of the developing device as a supplied portion of the image forming unit with reference to FIG. 2. The developing device 5Y includes a developing roller 51, a doctor blade 52, two conveying screws 55, and a toner concentration sensor 56. The developing roller 51 faces the photoconductor drum 1Y. The doctor blade 52 faces the developing roller 51. The two conveying screws 55 are disposed within developer housings 53 and 54. The toner concentration sensor 56 detects a concentration of toner in developer G. The developing roller 51 includes magnets and a sleeve. The magnets are fixed inside the developing roller 51. The sleeve rotates around the magnets. The developer housings 53 and 54 contain the two-component developer G including carrier (i.e., carrier particles) and toner (i.e., toner particles).

The developing device 5Y described above operates as follows. The sleeve of the developing roller 51 rotates in the direction indicated by an arrow in FIG. 2. The developer G is borne on the developing roller 51 by a magnetic field generated by the magnets. As the sleeve rotates, the developer G moves along the circumference of the developing roller 51. The developer G in the developing device 5Y is adjusted so that the ratio of toner (i.e., toner concentration) in the developer G is within a specified range. Specifically, the toner supply device 90 (see FIG. 3) serving as a supply device that supplies toner from the toner container 32Y to the developer housing 54 (see FIG. 2) according to the toner consumption in the developing device 5Y.

The toner supplied in the developer housing 54 is stirred and mixed together with the developer G and circulated through the two developer housings 53 and 54 by the two conveying screws 55 (i.e., in a longitudinal direction perpendicular to the plane on which FIG. 2 is illustrated). The toner in the developer G is electrically charged by friction together with the carrier and thus is attracted to the carrier. Both the toner and the carrier are borne on the developing roller 51 due to a magnetic force generated on the developing roller 51. The developer G borne on the developing roller 51 is conveyed in a direction (counterclockwise) indicated by an arrow in FIG. 3 and reaches a position opposite the doctor blade 52. The doctor blade 52 adjusts the amount of the developer borne on the developing roller 51 to an appropriate amount. Thereafter, the developer G on the developing roller 51 is conveyed to a position opposite the photoconductor drum 1Y (a developing area). The toner is attracted to the electrostatic latent image formed on the photoconductor drum 1Y by an electric field generated in the development area. Subsequently, as the sleeve rotates, the developer G remaining on the developing roller 51 reaches an upper portion of the developer housing 53 and separates from the developing roller 51.

Next, with reference to FIG. 3, a configuration and operations of the toner supply device 90 serving as the supply device is briefly described. The toner supply device 90 rotationally drives a container body 33 of the toner container 32Y (i.e., a powder container) disposed in the installation section 31 in a predetermined direction (i.e., in the direction indicated by arrow in FIG. 3), discharges the toner contained in the toner container 32Y to the outside of the toner container 32Y, and guides the toner to the developing device 5Y as the supplied portion via a sub-hopper 70. The toner supply device 90 includes a toner supply path (i.e., a toner conveyance path). In FIG. 3, the arrangement direction of the toner container 32Y, the toner supply device 90, and the developing device 5Y is changed to facilitate understanding. Actually, the longitudinal axes of the toner container 32Y and a part of the toner supply device 90 are perpendicular to the plane on which FIG. 3 is illustrated (see FIG. 1). In addition, the orientation and arrangement of conveying tubes 95 and 96 are also simplified and illustrated.

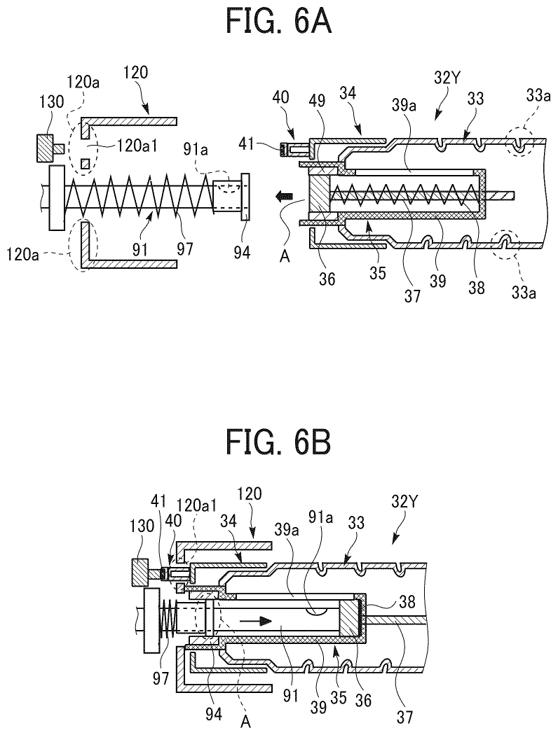

The toner supply devices 90 supply the color toners contained in the toner containers 32Y, 32M, 32C, and 32K installed in the installation section 31 in the apparatus body of the image forming apparatus 100 to the corresponding developing devices 5Y, 5M, 5C, and 5K, respectively. The amount of toner supplied to each developing device 5 is determined based on the amount of toner consumed in the corresponding developing device 5. The four toner supply devices 90 have a similar configuration except the color of the toner used in the image forming processes. Specifically, with reference to FIG. 3 (and FIGS. 6A and 6B), when the toner container 32Y is attached to the installation section 31 of the apparatus body of the image forming apparatus 100, a toner conveying nozzle 91 (i.e., nozzle) of the apparatus body of the image forming apparatus 100 pushes and moves a shutter 36 of the toner container 32Y. As a result, the toner conveying nozzle 91 is inserted into the toner container 32Y (i.e., the container body 33) via a through hole A. Accordingly, the toner contained in the toner container 32Y can be discharged through the toner conveying nozzle 91. The toner container 32Y includes a grip 33d at a bottom portion (on the left side in FIG. 3) of the toner container 32Y so that a user easily handles and installs the toner container 32Y to the installation section 31. The grip 33d has an outer diameter smaller than the outer diameter of the container body 33. The user grips the grip 33d to install the toner container 32Y in the installation section 31 and take out the toner container 32Y from the installation section 31.

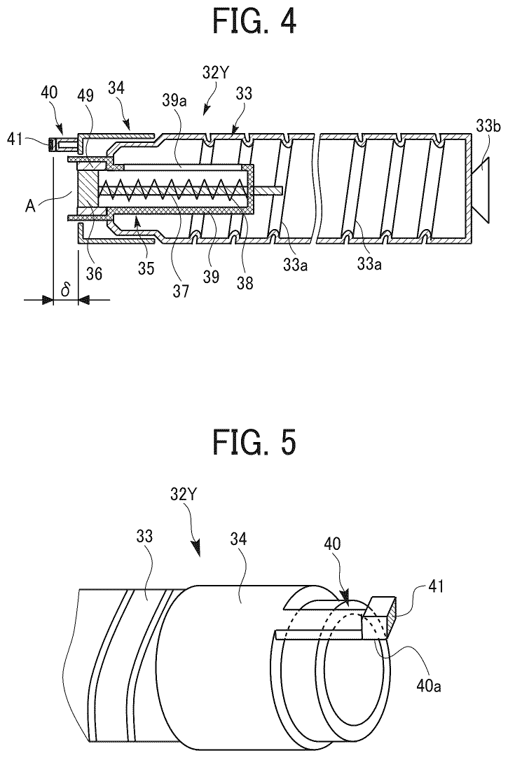

With reference to FIGS. 3 and 4, the toner container 32Y includes the substantially cylindrical container body 33 having a spiral groove 33a extending in the longitudinal direction (the left-and-right directions in FIG. 3, and the axial direction of the container body 33). Specifically, the spiral groove 33a is formed from an outer circumferential surface toward an inner circumferential surface of the container body 33 so that a rotation of the container body 33 convey the toner in the container body 33 from the left to the right in FIG. 3. The toner conveyed from the left to the right in FIG. 3 inside the container body 33 is discharged to the outside of the toner container 32Y through the toner conveying nozzle 91. The toner container 32Y includes a gear 33b meshing with a drive gear 110 of the apparatus body of the image forming apparatus 100. The gear 33b is disposed on the outer circumferential surface of the container body 33 on a head side (on the right side of the container body 33 in FIG. 3). When the toner container 32Y is installed to the installation section 31, the gear 33b of the container body 33 meshes with the drive gear 110 of the apparatus body of the image forming apparatus 100. As a drive motor 115 is driven, the driving force (rotational drive) is transmitted from the drive gear 110 to the gear 33b, thus driving the container body 33 to rotate. In other words, the drive motor 115 and the drive gear 110 function as a drive mechanism to drive to rotate the container body 33. A configuration and operation of the toner container 32Y (powder container) are described in further detail later.

With reference to FIG. 3, a conveying screw 92 is disposed inside the toner conveying nozzle 91. As a motor 93 rotates the conveying screw 92, the conveying screw 92 conveys the toner flowing into the toner conveying nozzle 91 from an opening 91a (i.e., inflow port, see FIGS. 6A and 6B) in the toner container 32Y from the left to the right in FIG. 3. Thus, the toner is discharged through an outlet port of the toner conveying nozzle 91 to a hopper 81. The hopper 81 is disposed below the outlet port of the toner conveying nozzle 91 as a powder conveying nozzle via a dropping path 82. The toner stored in the hopper 81 is conveyed to the developing device 5Y downstream from the hopper 81 by a conveyor. The conveyance configuration by the conveyor in FIG. 3 is described below. A suction port 83 is disposed in the bottom portion of the hopper 81 and coupled to one end of the conveying tube 95 as a tube. The conveying tube 95 is made of a flexible rubber material with low affinity for toner, and the other end of the conveying tube 95 is coupled to a developer pump 60 (serving as a diaphragm pump). The developer pump 60 is coupled to the developing device 5Y via the sub-hopper 70 and a conveying tube 96. With such a configuration of the toner supply device 90, the drive motor 115 as the drive mechanism rotates the container body 33 of the toner container 32Y to discharge the toner stored in the toner container 32Y to the outside of the toner container 32Y through the toner conveying nozzle 91. The toner discharged from the toner container 32Y falls through the dropping path 82 and is stored in the hopper 81. The developer pump 60 operates to suck the toner stored in the hopper 81 together with air from the suction port 83 and convey the toner from the developer pump 60 to the sub-hopper 70 through the conveying tube 95. The toner conveyed to and stored in the sub-hopper 70 is appropriately supplied into the developing device 5Y via the conveying tube 96. In other words, the toner in the toner container 32Y is conveyed in the direction indicated by dashed arrows in FIG. 3. The conveyor is not limited to the above-described configuration, and for example, the toner stored in the hopper 81 may be conveyed directly to the developing device 5Y by a screw disposed in the hopper 81.

A toner sensor 86 is disposed near the suction port 83 and indirectly detects a state in which the toner contained in the toner container 32Y is depleted (i.e., toner end state) or a state in which the toner contained in the toner container 32Y is nearly depleted (i.e., toner near end state). The toner is discharged from the toner container 32Y based on the detection result of the toner sensor 86. Specifically, for example, a piezoelectric sensor or a light transmission sensor can be used as the toner sensor 86. A height of the detection surface of the toner sensor 86 is set so that the amount of toner (deposition height) deposited above the suction port 83 is a target value. A drive timing and a drive duration of the drive motor 115 are controlled to rotationally drive the toner container 32Y (container body 33) based on the detection result of the toner sensor 86. Specifically, when the toner sensor 86 detects that toner is not deposited on a detection position of the toner sensor 86, the drive motor 115 is driven for a specified time. When the toner sensor 86 detects that toner is present on the detection position, the drive motor 115 stops. If the toner sensor 86 continuously detects that toner does not exist at the detection position even when the above-described control is performed repeatedly, a controller of the image forming apparatus determines that the toner contained in the toner container 32Y is depleted (i.e., toner end state) or that the toner contained in the toner container 32Y is nearly depleted (i.e., toner near end state).

With reference to FIGS. 4, 5, 6A, and 6B, a detailed description is given of the toner containers 32Y, 32M, 32C, and 32K further in detail below. FIGS. 4, 6A, and 6B are cross-sectional side views of the toner container 32Y. The drawings illustrate the toner container 32Y opposite to the side illustrated in FIGS. 3 and 5. The left and right of FIGS. 3 and 5 are reversed in FIGS. 4, 6A, and 6B). In FIGS. 4, 6A, and 6B, the gear 33b of the container body 33 is not illustrated for the sake of simplicity.

As described above with reference to FIGS. 1 to 3, the toner container 32Y stores toner as powder therein and is detachably attached to the apparatus body of the image forming apparatus 100. With reference to FIGS. 4, 5, 6A, and 6B, the toner container 32Y includes the container body 33, a cap 34, and a shutter unit 35. The shutter unit 35 includes, for example, the shutter 36, a rod 37, a compression spring 38, and a case 39. The shutter unit 35 is held united with the cap 34 and is installed to enter the inside of the container body 33. The shutter 36 is installed to be fittable into the through hole A of the container body 33. The container body 33 is a bottle having the spiral groove 33a on the inner circumferential surface (inner circumference) of the container body 33. The cap 34 is formed to cover a side of the container body 33 on which a shutter 36 is provided. When the toner container 32Y is attached to the apparatus body of the image forming apparatus 100 (the installation section 31), the container body 33 is rotated by the drive motor 115 (drive mechanism) disposed in the apparatus body of the image forming apparatus 100, with the cap 34 (shutter unit 35) non-rotatably held in the installation section 31. Toner contained in the toner container 32Y is discharged via the toner conveying nozzle 91.

With reference to FIGS. 6A and 6B, the shutter 36 opens and closes the through hole 34a1 to which the toner conveying nozzle 91 (which is installed in the apparatus body of the image forming apparatus 100) is inserted in conjunction with the installation operation of the toner container 32Y to the apparatus body of the image forming apparatus 100. The shutter 36 is made of a resin material and molded together with the rod 37. The shutter 36 is fitted and locked to the cap 34 from the inside of the toner container 32Y with respect to the through hole A, and is configured not to come off to the outside of the toner container 32Y. When the shutter 36 closes the through hole A, no toner is discharged from the toner container 32Y. When the shutter 36 opens the through hole A, the toner can be discharged from the toner container 32Y. The through hole A is a substantially columnar hole centered on the rotation center of the container body 33, and communicates with the container body 33. The shutter 36 is a stopper-shaped member to fit into the through hole A having such a columnar shape.

The toner container 32Y includes a seal 49 to seal a gap between the shutter 36 and the through hole A with the through hole A being closed by the shutter 36. Specifically, the seal 49 is made of an elastic material such as foamed polyurethane or felt and sticked to an entire inner circumferential surface of the through hole A. The seal 49 seals the gap between the shutter 36 and the through hole A in the state in which the through hole A is closed by the shutter 36, so that the toner stored in the container body 33 does not leak from the through hole A.

The rod 37 is united with the shutter 36. The rod 37 extends in an opening-and-closing directions of the shutter 36 (in the left-and-right direction in FIGS. 4, 6A, and 6B) inside the toner container 32Y. As illustrated in FIG. 4, the rod 37 is disposed so that the axis of the rod 37 substantially coincides with the rotation center of the container body 33. Such a configuration reduces an inconvenience such as a positional displacement of the shutter 36 when the container body 33 is driven to rotate.

With reference to FIGS. 6A and 6B, the toner container 32Y according to the present embodiment is detachably attached to the apparatus body of the image forming apparatus 100 with the shutter unit 35 non-rotatably held by a main body cover 120 of the apparatus body of the image forming apparatus 100. In response to receipt of rotational driving force from the apparatus body of the image forming apparatus 100, the container body 33 rotates around the toner conveying nozzle 91.

The shutter unit 35 of the cap 34 has the through hole A extending in a direction in which the toner conveying nozzle 91 is inserted (i.e., the insertion direction, and the left-and-right directions in FIGS. 4, 6A, and 6B). In the shutter unit 35, the case 39 of the shutter unit 35 holds the rod 37 on the opposite side (i.e., the right side in FIGS. 4, 6A, and 6B) to the side on which the shutter 36 is disposed inside the toner container 32Y so that the rod 37 is movable in the opening-and-closing directions. The case 39 is has a substantially U shape extending in the left-and-right directions of FIGS. 4, 6A, and 6B inside the toner container 32Y (i.e., the container body 33). The compression spring 38 as a biasing member is wound around the rod 37 between the shutter 36 and a wall of the case 39. The compression spring 38 biases the shutter 36 in the direction to which the through hole A is closed (i.e., toward the left side in FIGS. 4, 6A, and 6B).

With such a configuration, the shutter 36 is pushed by the toner conveying nozzle 91 in conjunction with the installation operation of the toner container 32Y to the apparatus body of the image forming apparatus 100 (i.e., the installation section 31). The shutter 36 moves to the inside of the toner container 32Y with the rod 37 against the biasing force of the compression spring 38 (i.e., the biasing member) and opens the through hole A. Specifically, the shutter 36 (and the rod 37) moves in the order as illustrated in FIGS. 6A and 6B to open the through hole A. In contrast, pushing of the toner conveying nozzle 91 against the shutter 36 is released in conjunction with the removal operation of the toner container 32Y from the apparatus body of the image forming apparatus 100 (i.e., the installation section 31). The shutter 36 moves toward the through hole A with the rod 37 by the biasing force of the compression spring 38 and closes the through hole A. Specifically, the shutter 36 (and the rod 37) moves in the order as illustrated in FIGS. 6B and 6A to close the through hole A. As illustrated in FIG. 6B, when the installation of the toner container 32Y in the apparatus body of the image forming apparatus 100 is completed, the shutter 36 contacts the wall of the case 39, and the compression spring 38 is stored in the recess of the shutter 36. Such a configuration can prevent an inconvenience that toner in the toner container 32Y adheres to the compression spring 38 when the toner container 32Y is set in the apparatus body of the image forming apparatus 100.

With reference to FIGS. 6A and 6B, in the present embodiment, the toner conveying nozzle 91 is provided with a fitting member 94 that fits to the shutter 36 in conjunction with the insertion operation into the through hole A. Specifically, the fitting member 94 has an outer diameter equal to the outer diameter of the shutter 36, and is formed in a substantially cylindrical shape to be fittable with the shutter 36. The fitting member 94 is slidable along the main portion of the toner conveying nozzle 91 in an installation direction of the toner container 32Y indicated by an arrow in FIG. 6A. A compression spring 97 is attached on the toner conveying nozzle 91 to bias the fitting member 94 downstream in the insertion direction, indicated by an arrow in FIG. 6B, in which the toner conveying nozzle 91 is inserted into the toner container 32Y (i.e., toward the right side in FIG. 6B). The fitting member 94 also functions as a cover that covers an opening 91a of the toner conveying nozzle 91. As illustrated in FIG. 6A, the fitting member 94 closes the opening 91a when the toner container 32Y is not installed. As illustrated in FIG. 6B, the fitting member 94 slides and moves, and the main portion of the toner conveying nozzle 91 is inserted into the inside of the container body 33 when the toner container 32Y is installed. With such a configuration, when the toner conveying nozzle 91 is inserted into the toner container 32Y in conjunction with the installation operation of the toner container 32Y, the fitting member 94 is biased by the compression spring 97 to fit the inner circumference. In contrast, when the toner conveying nozzle 91 is pulled out from the toner container 32Y in conjunction with the detaching operation of the toner container 32Y, the fitting member 94 is pulled out from the inner circumference.

With reference to FIGS. 4, 5, 6A, and 6B, the configuration and operations regarding the toner container 32Y as the powder container in the present embodiment are described below. As described above, the toner container 32Y (powder container) according to the present embodiment includes the container body 33 containing toner as powder, the cap 34 held by the image forming apparatus 100 in a non-rotatable manner, the through hole A through which the toner conveying nozzle 91 as a powder conveying nozzle of the apparatus body of the image forming apparatus 100 is inserted into the container body 33, and the shutter 36 that opens and closes the through hole A.

The cap 34 is formed such that the container body 33 is inserted therethrough and the toner conveying nozzle 91 (powder conveying nozzle) of the apparatus body of the image forming apparatus 100 can be inserted into the container body 33 through the through hole A. The cap 34 is formed to cover a head portion of the container body 33 (a portion having an outer diameter smaller than the outer diameter of the main portion of the container body 33), and the outer diameter of the cap 34 is formed to be substantially equal to the outer diameter of the main portion of the container body 33 (a large-diameter portion in which the spiral groove 33a is formed). The through hole A is formed in the cap 34 to communicate with the inside of the container body 33 in order to insert the toner conveying nozzle 91 into the container body 33, and is formed in the shutter unit 35 in the present embodiment. The shutter 36 is installed to be fittable into the through hole A. The shutter 36 opens and closes the through hole A in conjunction with an operation of attachment and detachment of the toner container 32Y (powder container) to and from the apparatus body of the image forming apparatus 100.

With reference to FIGS. 4, 5, 6A, and 6B, the cap 34 of the toner container 32Y (the powder container) according to the present embodiment includes an identification (ID) chip 41 as an information storage medium. The ID chip 41 functions as an information storage medium that contacts the reading device 130 of the apparatus body of the image forming apparatus 100 to be able to communicate with a reading device 130 in conjunction with an operation of attaching the toner container 32Y (the powder container) to the apparatus body of the image forming apparatus 100 in an attachment direction (the direction indicated by a black arrow in FIG. 6A). The information exchanged between the reading device 130 and the ID chip 41 on the of the toner container 32Y includes information (such as color, volume, and production lot) on the toner in the toner container 32Y or information on whether the container itself is recycled. Image forming conditions in an image forming device of the apparatus body of the image forming apparatus 100 are appropriately adjusted based on the information read from the ID chip 41 by the reading device 130. The information exchanged between the reading device 130 and the ID chip 41 is not limited to information transmitted from the ID chip 41 to the reading device 130, and includes information transmitted from the reading device 130 to the ID chip 41 (for example, a usage history of the toner container 32Y in the image forming apparatus 100). The reading device 130 may include connection terminals that can be connected to a plurality of terminals (including a ground terminal, for example) formed on the main surface of the ID chip 41.

In the present embodiment, the ID chip 41 (information storage medium) is disposed downstream from an entrance of the through hole A on the downstream side in the installation direction (the left in FIG. 4). In other words, as illustrated in FIGS. 4 and 5, the ID chip 41 is disposed at a position separated from the entrance of the through hole A by a specified distance 8 on the downstream side in the installation direction. Specifically, in the cap 34, a holder 40 that holds the ID chip 41 (information storage medium) protrudes downstream from the entrance of the through hole A in the installation direction. The holder 40 is disposed between the upper end and the lateral end, not at the upper-and-lower ends or the lateral ends, on the outer circumference of the cap 34 when the cap 34 is viewed in the rotation axis direction, the main body cover 120 (see FIGS. 6A and 6B) of the apparatus body of the image forming apparatus 100 is unlikely to be unnecessarily large in the vertical direction and the horizontal direction.

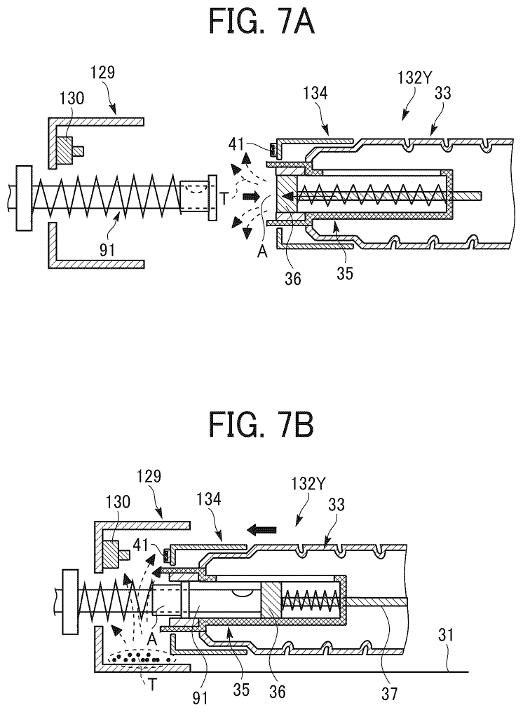

As described above, in the toner container 32Y according to the present embodiment, the ID chip 41 is disposed at a position sufficiently away from the through hole A of the cap 34 in the installation direction, so that an inconvenience that toner that has flown up in the vicinity of the through hole A adheres to the ID chip 41 is unlikely to occur when the toner container 32Y is attached to or detached from the apparatus body of the image forming apparatus 100 as compared with a toner container 132Y in which the ID chip 41 is disposed adjacent to the through hole A of a cap 134 illustrated as a comparative example in FIGS. 7A and 7B.

Specifically, as illustrated in FIG. 7A as a comparative example, when the toner container 132Y is taken out from the apparatus body of the image forming apparatus 100 (in which a main body cover 129 is installed) in the direction indicated by the bold black arrow, the shutter 36 that has opened the through hole A forcibly closes the through hole A, so that the toner T adhered to the end surface of the shutter 36 near the entrance and in the vicinity of the entrance is blown out and flown up from the through hole A in the dashed arrow direction. Then, the toner T that has flown up adheres to the surface of the ID chip 41. When the toner container 32Y is removed from the apparatus body of the image forming apparatus 100 in the direction indicated by the bold black arrow, the toner T adhered to the toner conveying nozzle 91 may adhere to the lower portion of the main body cover 120. Accordingly, as illustrated in FIG. 7B as a comparative example, when the toner container 132Y is attached to the apparatus body of the image forming apparatus 100, if the gap between the left lateral surface of the cap 134 and the lateral surface of the main body cover 129 (the lateral surface opposite the left lateral surface of the cap 134) is narrow, the toner T (the toner T leaked from the toner container 32Y) accumulated on the main body cover 129 of the apparatus body of the image forming apparatus 100 is flown up in the direction indicated by the dashed arrow by the airflow generated by the attachment of the toner container 132Y. Then, the toner T that has flown up adheres to the surface of the ID chip 41 (the ID chip 41 immediately before contacting the reading device 130). When the toner T adheres to the ID chip 41 as described above, the information stored in the ID chip 41 may not be read well by the reading device 130, and the information may not be written well to the ID chip 41. In other words, there is a possibility that a communication failure caused by the ID chip 41 may occur. On the other hand, in the present embodiment, the ID chip 41 is disposed at a position sufficiently away from the through hole A (the end surface of the toner container) in the installation direction, even if the toner T is flown up by the air flow generated by the narrowing of the gap between the left lateral surface of the cap 134 and the lateral surface of the main body cover 129 as described with reference to FIGS. 7A and 7B, the ID chip 41 contacts the reading device 1130 before the toner T is flown up. Thus, the toner T is unlikely to adhere to the ID chip 41.

With reference to FIG. 5, in the present embodiment, the holder 40 of the cap 34 covers the lower portion of the ID chip 41 (information storage medium). In other words, a lower surface 40a of the holder 40 covers the lower portion of the ID chip 41. With such a configuration, the toner T that has flown up from the lower portion of the ID chip 41 is directly unlikely to adhere to the ID chip 41.

With reference to FIGS. 6A and 6B, the image forming apparatus 100 according to the present embodiment includes the main body cover 120 that covers a part or all of the outer circumference of the cap 34 of the toner container 32Y (the powder container) attached to the apparatus body of the image forming apparatus 100. The main body cover 120 is provided with the reading device 130 and the toner conveying nozzle 91 (the powder conveying nozzle). The main body cover 120 has a wall 120a (which is a wall standing in the vertical direction to oppose the end surface of the cap 34) opposite the cap 34 of the toner container 32Y (the powder container) attached to the apparatus body of the image forming apparatus 100. The wall 120a has a hole 120a1 through which the ID chip 41 (information storage medium) held by the cap 34 is inserted. The reading device 130 is disposed downstream from the wall 120a in the installation direction (the left in FIGS. 6A and 6B). When the toner container 32Y (the cap 34) is attached to the apparatus body of the image forming apparatus 100 (the main body cover 120), the ID chip 41 is inserted into the hole 120a1 of the main body cover 120 (the wall 120a) and coupled to the reading device 130 located outside the wall 120a. In other words, the ID chip 41 enters the hole 120a1 before the attachment of the toner container 32Y (the cap 34) to the apparatus body of the image forming apparatus 100 (the main body cover 120) is completed. Accordingly, the inconvenience that the toner T (the toner that has flown up inside the main body cover 120) adheres to the ID chip 41 as described above with reference to FIGS. 7A and 7B is unlikely to occur, and the toner T that has flown up inside the main body cover 120 is unlikely to adhere to the reading device 130.

### First Modification

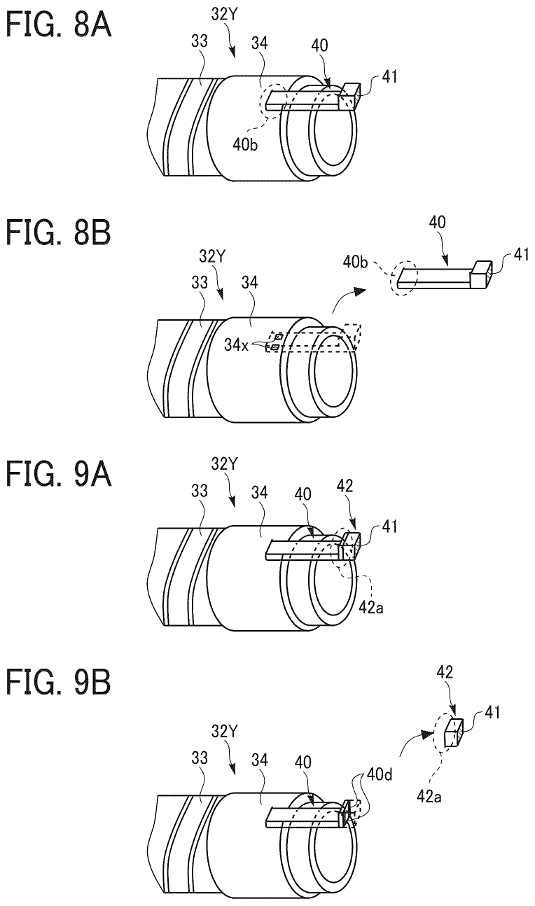

As illustrated in FIGS. 8A and 8B, in the toner container 32Y (the powder container) according to a first modification, the entire holder 40 (a portion protruding from the cap 34 toward the downstream side in the installation direction) constitutes a holding unit 42 that is detachably held by the cap 34. As illustrated in FIG. 8A, an engaging portion 40b formed at the root of the holder 40 engages with an engaged portion 34x (see FIG. 8B) formed on the outer circumferential surface of the cap 34, so that the holder 40 (in which the ID chip 41 is held) is attached to the cap 34. Then, as illustrated in FIG. 8B, the engagement between the engaging portion 40b and the engaged portion 34x is released, so that the holder 40 is taken out from the cap 34 to perform replacement or maintenance of the ID chip 41. The engaging portion 40b and the engaged portion 34x may be engaged by snap fastening, for example.

### Second Modification

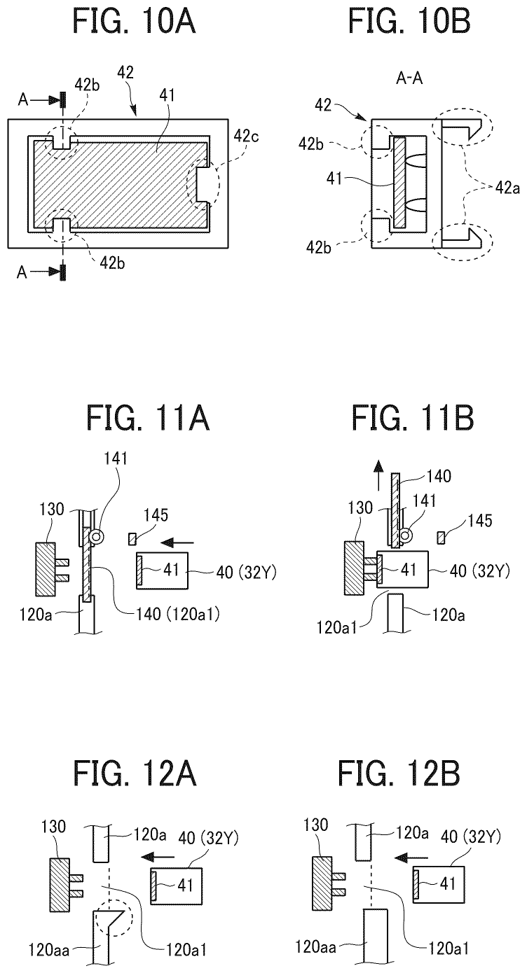

As illustrated in FIGS. 9A and 9B, in the toner container 32Y (the powder container) according to a second modification, a part (a tip portion) of the holder 40 constitutes a holding unit 42 that is removably held by the cap 34. As illustrated in FIG. 9A, the engaging portion 42a (see FIG. 10B) formed in the holding unit 42 (in which the ID chip 41 is held) engages with an engaged portion 40d (see FIG. 9B) formed at the tip of the fixing portion of the holder 40 protruding from the cap 34, so that the holding unit 42 is attached to the cap 34 (the fixing portion of the holder 40). Then, as illustrated in FIG. 9B, the engagement between the engaging portion 42a and the engaged portion 40d is released, so that the holding unit 42 can be taken out from the cap 34 (the fixing portion of the holder 40) to perform replacement or maintenance of the ID chip 41. In particular, with reference to FIGS. 10A and 10B, in the second modification, the holding unit 42 (the holder 40) removably holds the ID chip 41 (information storage medium). The holding unit 42 (the holder 40) is provided with elastically deformable locking portions 42b and 42c that lock the ID chip 41 not to fall off. The three locking portions 42b and 42c are formed to protrude from the edges covering the periphery of the ID chip 41 into the main surface when viewed in the direction orthogonal to the main surface of the ID chip 41. When the ID chip 41 is attached on the holding unit 42, an operator sets the ID chip 41 in the holding unit 42 in a state where the locking portions 42b and 42c are elastically deformed, and releases the elastically deformed state, so that the ID chip 41 in the holding unit 42 is restricted from falling off. On the other hand, when an operator takes out the ID chip 41 from the holding unit 42, the operator takes out the ID chip 41 from the holding unit 42 in a state where the locking portions 42b and 42c are elastically deformed. The ID chip 41 is attachable to and detachable from the holding unit 42 (the holder 40) in this manner, so that replacement or maintenance of the ID chip 41 can be easily performed.

### Third Modification

As illustrated in FIGS. 11A and 11B, the image forming apparatus 100 according to a third modification includes an opening-and-closing member 140 that opens and closes the hole 120a1 of the main body cover 120 (the wall 120a) in conjunction with the attachment and detachment of the toner container 32Y (the powder container) to and from the apparatus body of the image forming apparatus 100. Specifically, the apparatus body of the image forming apparatus 100 (the main body cover 120) includes a photosensor 145 that optically detects the ID chip 41 (the holder 40) approaching the hole 120a1. When the photosensor 145 detects the ID chip 41 approaching the hole 120a1 during attachment of the toner container 32Y, the motor that rotates the pinion gear 141 (meshed with a rack gear formed on the opening-and-closing member 140) is driven, and thus the opening-and-closing member 140 that is in the closed state as illustrated in FIG. 11A becomes the open state (moves upward) as illustrated in FIG. 11B. Then, the ID chip 41 and the reading device 130 are coupled to each other via the hole 120a1. On the other hand, when the toner container 32Y is taken out, the operation opposite to the operation when the toner container 32Y is installed is performed, so that the opening-and-closing member 140 is switched from the open state to the closed state. The opening-and-closing mechanism of the opening-and-closing member 140 is not limited to the above-described mechanism, and for example, a mechanism that opens and closes only by a mechanical mechanism without using the photosensor 145 or a motor may be used. As described above, in the third modification, the opening-and-closing member 140 that opens and closes the hole 120a1 in conjunction with the attachment and detachment of the toner container 32Y is disposed, so that an inconvenience that toner adheres to the ID chip 41 and the reading device 130 can be further reduced.

### Fourth Modification

As illustrated in FIGS. 12A and 12B, in the image forming apparatus 100 in a fourth modification, the lower portion of the wall 120a of the main body cover 120 protrudes toward the upstream side in the installation direction (the right in FIGS. 12A and 12B) as compared with the upper portion of the hole 120a1. Specifically, in the example of FIG. 12A, the wall 120a above the hole 120a1 extends straight in the vertical direction, whereas a wall 120aa below the hole 120a1 has a portion corresponding to the edge of the hole 120a1 protruding in a tapered shape toward the upstream side in the installation direction. In the example of FIG. 12B, the wall 120aa located below the hole 120a1 is shifted to the upstream side in the installation direction as compared with the wall 120a above the hole 120a1. With such a configuration, the lower portion of the hole 120a1 in the wall 120a protrudes to the upstream side in the installation direction, so that toner that has flown up in the lower portion of the hole 120a1 is unlikely to directly enter the hole 120a1. Thus, an inconvenience of the toner adhering to the ID chip 41 and the reading device 130 can be further reduced.

### Fifth Modification

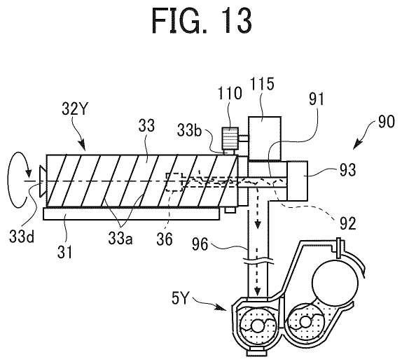

As illustrated in FIG. 13, the toner supply device 90 according to a fifth modification does not use the developer pump 60 illustrated in FIG. 3, but directly supplies toner discharged from the toner container 32Y to the developing device 5Y via the conveying tube 96. Even in the toner container 32Y detachably attached to the toner supply device 90 (the apparatus body of the image forming apparatus 100), the ID chip 41 is disposed downstream from the downstream entrance of the through hole A in the installation direction, so that the toner is unlikely to adhere to the ID chip 41.

As described above, the toner container 32Y according to the present embodiment is a powder container that is attachable to and detachable from the apparatus body of the image forming apparatus 100, and includes the container body 33 that contains toner (powder). The shutter 36 that opens and closes the through hole A in conjunction with the operation of attachment and detachment of the toner container 32Y to and from the apparatus body of the image forming apparatus 100 is installed to be fitted to the through hole A of the container body 33. The cap 34 is disposed to cover the side of the container body 33 on which the shutter 36 is disposed. The ID chip 41 (information storage medium) that contacts the reading device 130 of the apparatus body of the image forming apparatus 100 to be able to communicate with the reading device 130 in conjunction with the operation of attachment of the toner container 32Y to the apparatus body of the image forming apparatus 100 in the installation direction is installed in the cap 34. The ID chip 41 is disposed downstream from the downstream entrance of the through hole A in the installation direction. With such a configuration, toner (powder) is unlikely to adhere to the ID chip 41 (information storage medium).

In the present embodiment, the present disclosure is applied to the toner container 32Y that stores toner as powder. The application of the toner container of the present disclosure is not limited thereto. The present disclosure can also be applied to a powder container that stores, for example, two-component developer as powder containing toner and carrier. In the present embodiment, the present disclosure is applied to the toner container 32Y (the powder container) in which the contact type ID chip 41 (information storage medium) that communicatively contacts the reading device 130 of the apparatus body of the image forming apparatus 100 is installed, but the present disclosure can be applied to a powder container in which a non-contact type information storage medium that communicatively opposes the reading device 130 is installed. Even in such a case, advantageous effects equivalent to the effects of the above-described embodiments can be obtained.

A powder container includes a container body, a cap, a shutter, and an information storage medium. The store powder in the container body and is detachably attachable to an apparatus body of an image forming apparatus in an attachment direction. The cap has a through hole having an entrance at a downstream end of the through hole in the attachment direction and covers a portion of the container body. The shutter is fittable to the through hole and openably closes the through hole in response to an attachment and a detachment of the container body to and from the apparatus body. The information storage medium is on the cap, is disposed downstream from the entrance of the through hole in the attachment direction, and is electrically communicable with the image forming apparatus in response to the attachment of the container body to the apparatus body.

The cap has a holder holding the information storage medium. The holder protrudes downstream from the entrance of the through hole in the attachment direction. The holder includes an elastic locking portion to detachably hold the information storage medium. The holder is detachably attachable to the cap.

An image forming apparatus includes the powder container.

The image forming apparatus further includes a cover, a nozzle, and a reader. The cover covers an outer circumference of the cap when the container body is attached to the apparatus body. The nozzle is insertable into and removable from the container body in response to the attachment and the detachment of the container body to and from the apparatus body via the through hole. The reader reads information from the information storage medium. The cover includes a wall opposing the cap when the container body is attached to the apparatus body. The wall has a hole through which the information storage medium held by the cap is inserted. The reader is disposed downstream from the wall in the attachment direction.

The image forming apparatus further includes another shutter that openably closes the hole in response to the attachment and the detachment of the container body to and from the apparatus body. The wall has a protruding portion, protruding upstream from the wall in the attachment direction, at a lower portion of the hole.

Note that embodiments of the present disclosure are not limited to the above-described embodiments and it is apparent that the above-described embodiments can be appropriately modified within the scope of the technical idea of the present disclosure in addition to what is suggested in the above-described embodiments. The number, position, and shape of the components described above are not limited to those embodiments described above. Desirable number, position, and shape can be determined to perform the present disclosure.

Aspects of the present disclosure may be, for example, combinations of first to ninth aspects as follows.

### First Aspect

A powder container (e.g., the toner container 32Y) attachable to and detachable from an apparatus body of an image forming apparatus (e.g., the image forming apparatus 100) includes a container body (e.g., the container body 33), a shutter (e.g., the shutter 36), a cap (e.g., the cap 34), and an information storage medium (e.g., the ID chip 41). The container body stores powder inside. The shutter is disposed to be fittable to a through hole (e.g., the through hole A) of the container body and opens and closes the through hole in conjunction with an operation of attaching and detaching the powder container to and from the apparatus body of the image forming apparatus. The cap covers a portion in which the shutter is disposed in the apparatus body of the image forming apparatus. The information storage medium is disposed in the cap and communicatively contacts or opposes a reading device (e.g., the reading device 130) of the apparatus body of the image forming apparatus in conjunction with an attaching operation of the powder container to the apparatus body of the image forming apparatus in an attachment direction. The information storage medium is disposed downstream in an installation direction from a downstream entrance of the through hole in the installation direction.

### Second Aspect

In the powder container (e.g., the toner container 32Y) according to the first aspect, the cap (e.g., the cap 34) has a holder (e.g., the holder 40), which holds the information storage medium (e.g., the ID chip 41), that protrudes downstream from the entrance of the through hole (e.g., the through hole A) in the installation direction.

### Third Aspect

In the powder container (e.g., the toner container 32Y) according to the second aspect, the holder (e.g., the holder 40) has a locking portion (e.g., the locking portion 42b, 42c), which is elastically deformable, that holds the information storage medium (e.g., the ID chip 41) to be attachable and detachable, and locks the information storage medium not to fall off.

### Fourth Aspect

In the powder container (e.g., the toner container 32Y) according to the second or third aspect, the holder (e.g., the holder 40) is a holding unit (e.g., the holding unit 42) held to be attachable to and detachable from the cap (e.g., the cap 34).

### Fifth Aspect

An image forming apparatus (e.g., the image forming apparatus 100) includes the powder container (e.g., the toner container 32Y) according to any one of the first to fourth aspects removably installed to the apparatus body of the image forming apparatus.

### Sixth Aspect

The image forming apparatus (e.g., the image forming apparatus 100) according to the fifth aspect, further includes a main body cover (e.g., the main body cover 120) that covers a part or all of an outer circumference of the cap (e.g., the cap 34) of the powder container (e.g., the toner container 32Y) in a state of being attached to the apparatus body of the image forming apparatus.

### Seventh Aspect

In the image forming apparatus (e.g., the image forming apparatus 100) according to the sixth aspect, the main body cover (e.g., the main body cover 120) includes a wall (e.g., the wall 120a) opposing the cap (e.g., the cap 34) of the powder container (e.g., the toner container 32Y) in a state of being attached to the apparatus body of the image forming apparatus. The wall has a hole (e.g., the hole 120a1) through which the information storage medium (e.g., the ID chip 41) held by the cap is inserted. The reading device (e.g., the reading device 130) is disposed downstream from the wall in the installation direction.

### Eighth Aspect

The image forming apparatus (e.g., the image forming apparatus 100) according to the seventh aspect, further includes an opening-and-closing member (e.g., the opening-and-closing member 140) that opens and closes the hole (e.g., the hole 120a1) in conjunction with attachment and detachment of the powder container (e.g., the toner container 32Y) to and from the apparatus body of the image forming apparatus.

### Ninth Aspect

In the image forming apparatus (e.g., the image forming apparatus 100) according to the seventh or eighth aspect, a lower portion of the hole (e.g., the hole 120a1) of the wall (e.g., the wall 120a) protrudes on an upstream side of the wall in the installation direction compared to an upper portion of the hole (e.g., the hole 120a1) of the wall.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A powder container comprising:
a container body to store powder in the container body, the container body detachably attachable to an apparatus body of an image forming apparatus in an attachment direction;
a cap having a through hole having an entrance at a downstream end of the through hole in the attachment direction, the cap covering a portion of the container body;
a shutter fittable to the through hole, the shutter to openably close the through hole in response to an attachment and a detachment of the container body to and from the apparatus body; and
an information storage medium on the cap and disposed downstream from the entrance of the through hole in the attachment direction, the information storage medium electrically communicable with the image forming apparatus in response to the attachment of the container body to the apparatus body.

2. The powder container according to claim 1,
wherein the cap has a holder holding the information storage medium, and
wherein the holder protrudes downstream from the entrance of the through hole in the attachment direction.

3. The powder container according to claim 2,
wherein the holder includes an elastic locking portion to detachably hold the information storage medium.

4. The powder container according to claim 2,
wherein the holder is detachably attachable to the cap.

5. An image forming apparatus comprising the powder container according to claim 1.

6. The image forming apparatus according to claim 5, further comprising:
a cover to cover an outer circumference of the cap when the container body is attached to the apparatus body;
a nozzle insertable into and removable from the container body in response to the attachment and the detachment of the container body to and from the apparatus body via the through hole; and
a reader to read information from the information storage medium.

7. The image forming apparatus according to claim 6,
wherein the cover includes a wall opposing the cap when the container body is attached to the apparatus body,
wherein the wall has a hole through which the information storage medium held by the cap is inserted, and
wherein the reader is disposed downstream from the wall in the attachment direction.

8. The image forming apparatus according to claim 7, further comprising another shutter to openably close the hole in response to the attachment and the detachment of the container body to and from the apparatus body.

9. The image forming apparatus according to claim 7,
wherein the wall has a protruding portion, protruding upstream from the wall in the attachment direction, at a lower portion of the hole.
